(19) United States
(12) Patent Application Publication
(10) Pub. No.: US 2012/0024327 A1
(43) Pub. Date: Feb. 2, 2012

(54) TREATMENT MACHINE, IN PARTICULAR BOTTLE-CLEANING OR BOTTLE-PASTEURIZING MACHINE

(75) Inventors: Martin Brunkert, Langballig (DE); Arne Haase, Harrislee (DE)

(73) Assignee: KRONES AG, Neutraubling (DE)

(21) Appl. No.: 12/674,010

(22) PCT Filed: Jul. 31, 2008
(86) PCT No.: PCT/EP08/06326

§ 371 Date: Oct. 19, 2011

(30) Foreign Application Priority Data
Aug. 30, 2007 (DE) 10 2007 041 351.5

(51) Int. Cl. B08B 9/28; B08B 9/34; F16L 37/248

(52) U.S. Cl. 134/167 R

(57) ABSTRACT

A machine for treating containers, having a plurality of spray tubes which are oriented transversely to a distributor channel, and of which each is secured in a releasable manner, on at least one end, to a cutout of the distributor channel, the spray-tube end and the distributor channel have provided thereinbetween a bayonet lock which can be released by a partial rotary movement about an axis of rotation, essentially parallel to the spray-tube axis. The bayonet lock is provided with a seal and has locking elements which are in mutual engagement with one another on the distributor channel and on the spray-tube end.

### CROSS-REFERENCE TO RELATED APPLICATION

The present application claims the benefit of priority of International Patent Application No. PCT/EP2008/006326, filed Jul. 31, 2008, which application claims priority of German Application No. 10 2007 041 351.5, filed Jul. 30, 2007. The entire text of the priority application is incorporated herein by reference in its entirety.

### FIELD OF THE DISCLOSURE

The present disclosure refers to a machine for treating containers, such as for bottle cleaning in beverage bottling operations.

### BACKGROUND

In the bottle cleaning machine known from DE 1 864 636 U a common, eccentric-operated clamp-type bracket is provided for each group of spray tubes.

In a bottle cleaning and pasteurizing machine known from DE 1 203 630 C, each spray tube is inserted with one end into the cutout of the distributor channel, with a seal being compressed between a collar on the spray tube end and the distributor channel. Said end of the spray tube is pressed on by means of a crank mechanism from the opposite spray tube end. A closing mandrel is pressed by means of the crank mechanism into the other spray tube end having an open configuration.

In a spray tube known from DE 47 67 76 B, an end of the spray tube is closed and a screw cap, which is part of an interior cleaning brush, is seated in the opposite end of the spray tube. Water is supplied to the spray tube through a lateral connection.

### SUMMARY OF THE DISCLOSURE

It is the object of the present disclosure to improve a machine of the aforementioned type such that a faster assembly or disassembly of each spray tube is possible in an easy way.

The respective spray tube can be assembled and disassembled easily and rapidly in that the spray tube is rotated accordingly. Assembly or disassembly can be carried out by hand or by means of a suitable tool directly in the vicinity of the distributor channel, but this is just as well possible from the opposite end of the spray tube, i.e. at the place where access is best. The seal helps to avoid leakage in the mounting area and, while being compressed, it also ensures a safe position o f the mounted spray tube. A self-locking is given, so that the mounted spray tube cannot unlock unintentionally. Various cross-sectional shapes of spray tubes can be mounted in this way, for instance round tubes, quadratic tubes, rectangular tubes, or other profiled tubes, with the profiled tubes being rotatable in a particularly easy way. The bayonet lock also ensures a correct rotary positioning of the mounted spray tube in the properly locked state.

Expediently, the seal is an elastic sealing disk which is compressed between a locking disk secured to the spray tube end and a scaling area of the distributor channel that surrounds the cutout. The seal is removable and can be easily exchanged in case of wear. It fulfills a double function in the bayonet lock, on the one hand by frictional engagement and on the other hand through compression as a locking element of the bayonet lock, so that during operation of the machine an independent release of the mounted spray tube is prevented. The locking disk also fulfills a double function because it serves, on the one hand, a locking in the bayonet lock and, on the other hand, a pressing against the seal.

In an expedient embodiment an end section of the spray tube projects from the locking disk. At said place the sealing disk can be placed in a perfect way, the disk expediently comprising a penetration that may be adapted to the outer circumference of the spray tube, for instance in such a way that the seal is seated relatively tightly on the end section.

In an expedient embodiment the cutout in the distributor channel is circular. Its diameter has been chosen such that it permits the assembly of spray tubes of different cross-sectional shapes, i.e., it corresponds at least to the corner-to-corner dimension of profiled spray tubes. The outer diameter of the sealing disk is larger than the diameter of the cutout to provide a sealing in the case of a properly mounted bayonet lock between the end section of the spray tube and the distributor channel.

The locking disk can be welded on the outside onto the spray tube end. As part of the bayonet lock, it comprises at least two circumferentially spaced-apart and outwardly projecting extensions. Preferably, said extensions are arranged to be diametrically opposite each other and are made identical. The extensions cooperate with oppositely oriented locking hooks arranged on the distributor channel so as to secure the spray tube end in the cutout of the distributor channel. If necessary, the extensions and/or the locking hooks differ from one another so as to define a single mounting position of the spray tube.

In an expedient embodiment, the locking hooks are integrated, with a division corresponding to the cutout division of the distributor channel, into clamp-type sheet-metal rails. The clamp-type sheet metal rails are firmly welded to the distributor channel and can extend over the whole distributor channel length. Although the locking hooks are oriented in each cutout in a direction opposite to each other, identical clamp-type sheet-metal rails (identical parts) can be used in that a clamp-type sheet-metal rail is mounted opposite to the other rail.

The clamp-type sheet-metal rails are made in a particularly expedient way by laser cutting from sheet metal. Said processing method ensures high precision and optimum geometry for an easy tightening or releasing of the bayonet lock and, nevertheless, it provides a stable seat in the case of a properly operated bayonet lock.

Expediently, each locking hook comprises an introduction ramp that leads via a cam surface to a seat for the extension of the locking disk. Said seat can be defined at one side by a transition from the locking hook into the clamp-type sheet-metal rail. The introduction ramp facilitates the proper introduction of each extension and produces a tightening against the seal if the extension engages beyond the cam surface into the seat. The seal that will then slightly relax, but is still biased, presses the extension into the seat, so that the bayonet lock can no longer release itself independently. For releasing the bayonet lock, it may be expedient, where appropriate, to exert some pressure in the longitudinal direction of the spray tube so as to move the extension more easily beyond the cam surface again.

It is here important that the thickness of the sealing disk should be greater than the height of the clamp-type sheet-metal rail, so that the seal locks the bayonet lock on the one hand and seals it properly on the other hand.

In the case of a square spray tube the locking disk should comprise a square opening that shows a rotary dislocation relative to the extensions, preferably of about 15%. Said rotary dislocation puts the spray tube into an ideal operative position in the case of a properly fixed bayonet lock.

Unoccupied cutouts are closed by releasably mounted lids that define a boundary on the sealing surface next to the cutout and get hooked in the cutout. Each lid can be mounted either by means of a fastening element of its own or, similar to the locking disk on the spray tube, it may comprise extensions no that the lids can also be mounted by the locking hooks in the sealing position.

Since it is expedient to dismount or mount each spray tube as such alone, it is important that the outer diameter of the locking disk and the length of each locking hook as viewed in the longitudinal direction of the distributor channel are matched to the cutout division in the distributor channel such that each spray tube can be mounted or dismounted even if a spray tube positioned next thereto is still mounted.

### BRIEF DESCRIPTION OF THE DRAWINGS

An embodiment of the subject matter of the disclosure shall now be explained with reference to the drawings, in which:

FIG. 1 is a perspective view showing part of a machine for treating containers, with two distributor channels abutting on each other and with spray tubes mounted by means of bayonet locks in a direction transverse thereto;

FIG. 2 is a perspective view showing a detail for two bayonet locks positioned side by side;

FIG. 3 is a detail view showing a locking disk for a square or quadratic spray tube;

FIG. 4 is a perspective view showing a sealing disk for a square or quadratic spray tube, and

FIG. 5 is an axial section through a spray tube end in the mounted position.

### DETAILED DESCRIPTION OF THE PREFERRED EMBODIMENT

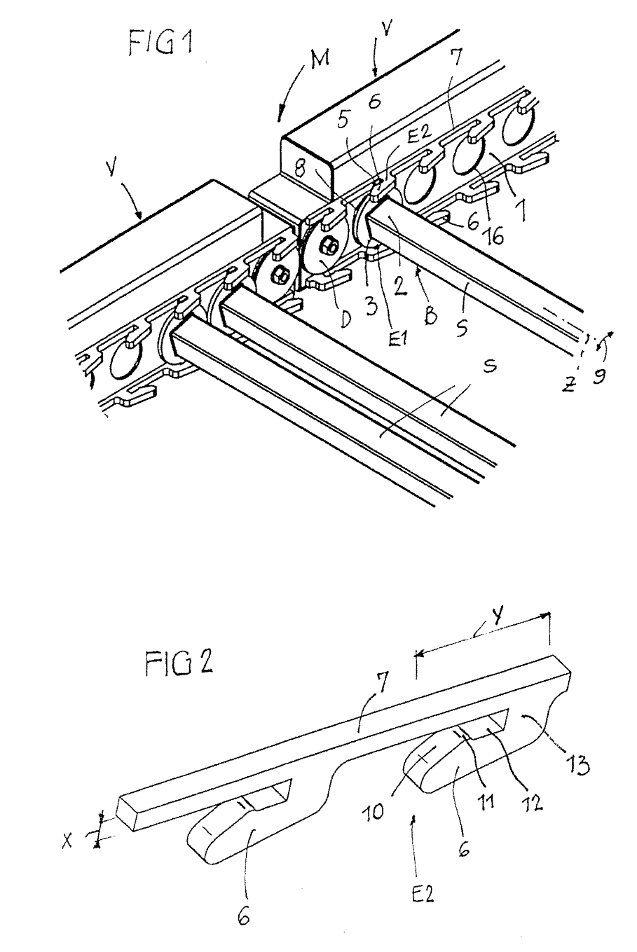

Of a machine M for treating containers, e.g. a bottle cleaning machine or a pasteurizing machine, FIG. 1 shows part of a treatment channel with longitudinally extending liquid distributor channels V (in the illustrated embodiment two distributor channels abutting on each other) and spray tubes S oriented in a direction transverse thereto. Each mounted spray tube S is releasably secured at one end with a bayonet lock B to a cutout 16 in a sealing surface 1 of the distributor channel V, and is e.g. hooked at the other end into a carrier. Spray openings (not shown) are provided in each spray tube S. The bayonet lock B is respectively operative between one end 2 of the spray tube S and the distributor channel V, and can he released or engaged by a partial rotary movement (double-headed arrow 9) about an axis of rotation Z that is substantially in parallel with the longitudinal axis of the spray tube S, namely such that each spray tube S has a specific rotary position relative to the distributor channel V.

The bayonet lock B comprises interengaged locking elements E1 on the spray tube end 2 and E2 on the distributor channel V.

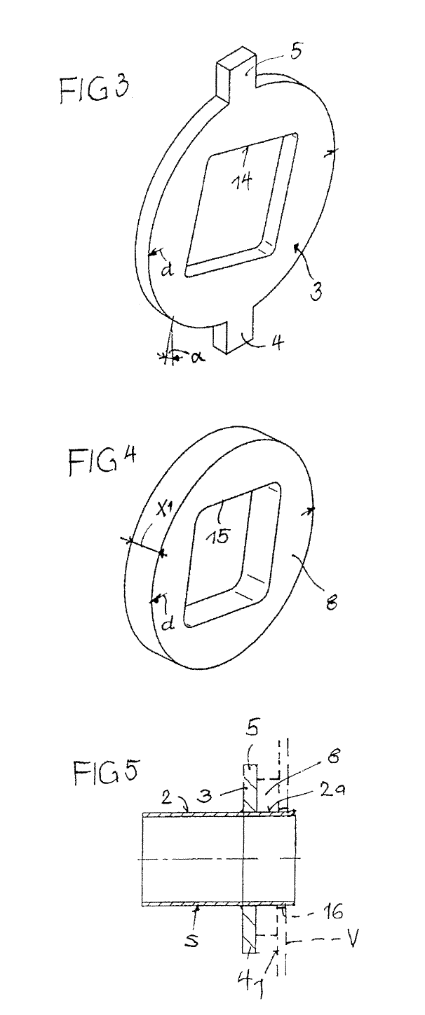

The locking elements E1 on the spray tube end 2 are formed on a locking disk 3, which is welded to the spray tube end 2, as diametrically arranged extensions 5, 4 (extension 4 can be seen in FIGS. 3 and 5) that are locked in place behind locking hooks 6 as locking elements E2 of the distributor channel.

With a predetermined division the distributor channel V comprises a number of cutouts 16, which are round in the illustrated embodiment and surrounded by the sealing surface 1. The locking hooks 6 are e.g. made integral with clamp-type clamping rails 7 and are oriented in opposite direction relative to one another in each cutout 16, i.e. the upper locking hooks 6 are oriented in FIG. 1 to the left side, whereas the lower locking hooks 6 are oriented in FIG. 1 to the right side. Expediently, a seal is incorporated into the bayonet lock B in the form of a sealing disk 8 made of elastic material, which is pressed by the locking disk 3 in the case of a properly fixed bayonet lock around the cutout 16 against the sealing surface 1.

Cutouts 16 that are not occupied by spray tubes S are closed by lids D that are releasably mounted between the looking hooks 6. Expediently, the lids D also comprise a sealing disk and are either secured by fastening elements in the cutouts 16 and on the sealing surface 1, respectively, or are formed, similar to the locking disks 3, with extensions 5, 4 that are secured by the locking hooks 6 to fix the lids D in their sealing position.

FIG. 2 illustrates one of the clamp-type sheet-metal rails 7, which are expediently made by laser cutting from a sheet metal. The clamp-type sheet-metal rail 7 comprises a bar-shaped elongated body that expediently extends over the whole length of the distributor channel and has a height x. Each locking hook 6 comprises an introduction ramp 10, at least one cam surface 11 next to the introduction ramp 10, and next to the cam surface 11 a recessed seat 12 for the respective extension 5, 4. The seat 12 can be defined at one sic e by a transition 13 extending from the looking hook 6 into the clamp-type sheet-metal rail 7.

The length of each locking hook (dimension y) and the diameter d of each locking disk 3 are matched to the cutout division in the distributor channel V such that each spray tube S can be inserted or removed even if the neighboring spray tube is in the operative position. Furthermore, each spray tube is fixed in the case of a properly operated bayonet lock in a predetermined rotary position relative to the distributor channel V. FIG. 1 shows square spray tubes S. The spray tubes S, however, could also be round tubes or square tubes or other profiled tubes.

For mounting a spray tube S the distributor channel V can be manipulated directly or also from the other end of the spray tube S. A simple tool is used, if necessary, to be able to rotate the spray tube S in an easy way.

Although the locking hooks 6 are oriented in opposite direction above and below the cutouts 16, the two clamp-type sheet-metal rails 7 may be identical parts. Expediently, the clamp-type sheet-metal rails are fixedly welded to the distributor channel V, just like the locking disks 3 onto the spray tube ends 2.

FIG. 3 shows a locking disk 3, for instance for a quadratic spray tube S. In the locking disk 3 a quadratic opening 14 is recessed, the opening corresponding to the external dimension of the quadratic spray tube. The locking disk 3 has an outer diameter d and, in the illustrated embodiment, two diametrically opposite, outwardly oriented extensions 4, 5 that upon the partial rotary movement 9 are moved beyond the introduction ramp 10 and the cam surfaces 11 up and into the seats 12. The quadratic opening 14 is offset relative to the extensions 4, 5 in rotary direction by an angle α, e.g. by about 15°, wherein in the mounted position of FIG. 1 the extensions 5, 4 are vertically upstanding and the quadratic spray tube S is positioned slightly rotated at the angle α.

FIG. 4 illustrates the sealing disk 8 for a quadratic spray tube 15. The sealing disk 8 is made of an elastic material and has a quadratic opening 15. The outer diameter D of the sealing disk 8 may be about the outer diameter d of the locking disk 3. The thickness x1 of the sealing disk 8 is much greater than the height x of the clamp-type sheet-metal rail 7, so that the sealing disk 8 is compressed if the extensions 4, 5 are locked in place in the seats 12.

FIG. 5 schematically illustrates the installed position of a spray tube S. As can be seen, a section 2a of the end 2 of the spray tube S projects beyond the locking disk 3, and the scaling disk 8 which is compressed by the locking disk 3 against the sealing surface 1 around the cutout 16 of the distributor channel V is seated on said section 2a. The diameter of the cutout 16 has been chosen such that different cross-sectional shapes of spray tubes S can be fastened in the same way, i.e. the diameter corresponds at least to the corner-to-corner dimension of a square spray tube (not shown) or a quadratic spray tube S. The outer diameter d of the sealing disk is at any rate greater than the diameter of the cutout 16 so as to provide for an efficient sealing.

For mounting a spray tube S by means of the bayonet lock B the spray tube S is attached to the sealing surface 1 in a position rotated relative to the locking hooks 6 until the extensions 5, 4 move past the locking hooks 6. The spray tube S is then rotated clockwise in FIG. 1 until the extensions 5, 4 have entered beyond the cam surfaces into the seats 12. The sealing disk 8 is thereby compressed and each extension 4, 5 is safely positioned in its seat 12 by way of an only partial relaxation of the sealing disk 8.

On condition that the side of the cam surface 11 oriented towards the seat 12 is also rounded or oblique, the bayonet lock can be easily released in just by rotating the spray tube S anticlockwise with compression of the sealing disk 8. Pressure is here exerted, if necessary, in the direction of the axis of the spray tube S and towards the distributor channel V so as to force the extensions 4, 5 more easily beyond the cam surfaces 11.

1. A machine for treating containers, particularly bottle cleaning or pasteurizing machine, comprising a plurality of spray tubes which are substantially in parallel with one another and oriented transversely to a longitudinally extending distributor channel, and of which each is secured in a releasable manner, on at least one end, to a cutout of the distributor channel, a bayonet lock which can be one of released or fixed by a partial rotary movement about an axis of rotation, essentially parallel to the spray-tube axis, and which is provided with a seal and arranged between the spray tube end and the distributor channel and has locking elements which are in mutual engagement with each other on the distributor channel and on the spray-tube end.

2. The machine according to claim 1, wherein the seal is a removable and elastic sealing disk which is compressed between a locking disk, secured to the spray tube end, and a sealing surface of the distributor channel, which surrounds the cutout.

3. The machine according to claim 1, and wherein an end section of the spray tube projects over the locking disk and that the sealing disk is threaded onto the end section.

4. The machine according to claim 1, wherein the cutout in the distributor channel is circular and formed with a diameter corresponding at least to the corner-to-corner dimension of a square spray tube and that the outer diameter of the sealing disk is larger than the diameter of the cutout.

5. The machine according to claim 2, wherein the sealing disk which is welded on the outside onto the spray tube end comprises, as locking elements, at least two circumferentially spaced-apart, diametrically opposite and outwardly projecting extensions, and that two oppositely disposed locking hooks for the extensions are mounted on the distributor channel, each time above and below each cutout, as locking elements.

6. The machine according to claim 5, wherein the locking hooks are integrated in conformity with the cutout division of the distributor channel into clamp-type sheet-metal rails, and that the clamp-type sheet-metal rails are secured to the distributor channel.

7. The machine according to claim 6, wherein the clamp-type sheet-metal rails are made by laser cutting from sheet metal.

8. The machine according to claim 5, wherein the locking hooks comprise an introduction ramp, a cam surface next to the introduction ramp, and next to the cam surface a seat for the extension, with the seat being defined at one side by a transition from the locking hooks to the clamp-type sheet-metal rail

9. The machine according to claim 2, wherein the thickness of the sealing disk is greater than the height of the clamp-type sheet-metal rail.

10. The machine according to claim 2, wherein for a square spray tube the locking disk comprises a square opening which can be slid onto the spray tube and which shows a rotary dislocation (α) relative to the extensions.

11. The machine according to claim 1, wherein a cutout that is not occupied by a spray tube is closed by a lid which is releasably mounted between the locking hooks on the cutout and on the sealing surface.

12. The machine according to claim 5, wherein the outer diameter of the locking disk and the length of each locking hook provided in the longitudinal direction of the distributor channel are matched to the cutout division in the distributor channel such that after release of the bayonet lock each spray tube is selectively removable as such from the distributor channel even if a spray tube nearest thereto is still mounted.

13. The machine according to claim 3, and wherein the sealing disk is threaded onto the end section by means of a penetration adapted to the round or square outer circumference of the spray tube.

14. The machine according to claim 6, and wherein the clamp-type sheet-metal rails are fixedly welded to the distributor channel, and are made identical, each substantially over the whole distributor channel length and with respect to one another.

15. The machine according to claim 10, wherein the rotary dislocation (α) is about 15%.

16. The machine according to claim 11, wherein the lid is fixed by means of a locking hook.
